(19) United States
(12) Patent Application Publication
(10) Pub. No.: US 2002/0089718 A1
(43) Pub. Date: Jul. 11, 2002

(54) Adjustable differential group delay generator and a polarization dispersion compensator incorporating it

(75) Inventors: Denis Penninckx, Nozay (FR); Olivier Leclerc, Saint Michel S/orge (FR); Stephanie Lanne, Paris (FR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: ALCATEL

(21) Appl. No.: 10/020,115

(22) Filed: Dec. 18, 2001

(30) Foreign Application Priority Data
Dec. 21, 2000 (FR) 00 16 756

(51) Int. Cl. H04J 14/06; H04B 10/00; H04B 10/04

(52) U.S. Cl. 359/122; 359/161; 359/156; 359/181

(57) ABSTRACT

A differential group delay generator includes a polarization splitter which splits an input signal into two components having orthogonal states of polarization, and an adjustable delay system for receiving one component. For high accuracy and a fast response, the adjustable delay system includes an adjustable phase modulator for applying phase modulation to the carrier wave of the component to supply an intermediate signal carried by a modified center wavelength, and a delaying dispersive component receiving the intermediate signal and supplying a delayed signal. Applications include polarization dispersion compensation in long-haul optical transmission, especially via standard fibers.

### CROSS-REFERENCE TO RELATED APPLICATIONS

This application is based on French Patent Application No. 00 16 756 filed Dec. 21, 2000, the disclosure of which is hereby incorporated by reference thereto in its entirety, and the priority of which is hereby claimed under 35 U.S.C. §119.

### BACKGROUND OF THE INVENTION

1. Field of the Invention

The invention relates to transmitting signals by optical means and more particularly to transmission at high bit rates on long-haul links using optical fibers.

The invention relates more precisely to a differential group delay generator for optical signals and a polarization dispersion compensator incorporating it.

2. Description of the Prior Art

A fiber optic transmission system typically includes:

a sender terminal modulating the power and/or the optical frequency of an optical carrier wave as a function of information to be transmitted,

an optical transmission link consisting of a section of monomode fiber carrying the signal sent by the sender terminal, and

a receiver terminal receiving the optical signal transmitted by the fiber.

The performance of an optical transmission system, especially in terms of signal quality and bit rate, is limited in particular by the optical properties of the link, which is subject to physical phenomena whose effect is to degrade the optical signals. Of all the phenomena that have been identified, optical power attenuation and chromatic dispersion appeared at first to represent the most severe constraints, and means have been proposed for at least partly remedying the degradation caused by these phenomena. Attenuation in the fibers has been compensated by optical amplifiers at the upstream or downstream end of the link or all along the link. Chromatic dispersion is a significant problem with standard fibers. One solution entails inserting a dispersion compensating fiber (DCF) into the link.

Another unfavorable phenomenon is polarization mode dispersion. Under current optical transmission operating conditions, this phenomenon is no longer negligible compared to chromatic dispersion if the wavelengths and especially the bit rates of the links are to be increased even more.

Even with no chromatic dispersion, and although the carrier wave supplied by a laser diode at the sender terminal is totally polarized, the fibers are subject to polarization dispersion whose effect is that a pulse sent by the sender terminal is received in a deformed state after it propagates in the fiber and has a duration greater than its original duration, for example.

The deformation is due to the birefringence of the fiber, the effect of which is to depolarize the optical signal during transmission. To a first approximation, the signal received at the end of the connecting fiber can be considered to be made up of two orthogonal components, one corresponding to a polarization state for which the propagation speed is maximum (fastest principal state of polarization) and the other corresponds to a polarization state for which the propagation speed is minimum (slowest principal state of polarization). In other words, a pulse signal received at the end of the connecting fiber can be considered to be made up of a first pulse signal polarized with a preferential state of polarization and arriving first and a second pulse signal propagating in a delayed propagation state and arriving with a time-delay referred to as the differential group delay (DGD), which depends in particular on the length of the link. The differential group delay and the two principal states of polarization (PSP) referred to above therefore characterize the link.

Consequently, if the sender terminal sends an optical signal consisting of a very short pulse, the optical signal received by the receiver terminal consists of two successive pulses polarized orthogonally and having a time shift equal to the DGD. As detection by the terminal consists of supplying in electrical form a measurement of the total optical power received, the detected pulse will have a temporal width increased as a function of the DGD. The time-delay can be of the order of 50 picoseconds for a standard fiber 100 kilometers long. Accordingly, for a binary signal whose bit rate is 10 gigabits per second, the time-delay therefore reaches half the bit period, which is not acceptable. The problem is obviously even more critical for higher bit rates.

An important aspect of the polarization mode dispersion phenomenon is that the differential group delay and the principal states of polarization of a link vary in time as a function of many factors, such as vibration and temperature. Accordingly, unlike chromatic dispersion, polarization dispersion must be considered to be a random phenomenon. In particular, the polarization dispersion of a link is characterized by the polarization mode dispersion delay (PMDD), defined as the average measured DGD value.

To be more precise, it can be shown that polarization dispersion can be represented by a vector with random rotation Ω in the Poincaré space in which the states of polarization of an optical wave are usually represented by a polarization state vector S, known as the Stokes vector, the end of which is situated on a sphere.

FIG. 1 shows the main vectors involved: the state of polarization vector S of an optical signal, the polarization dispersion vector Ω of the link, and the vector e of the principal states of polarization of the link. Φ is the angle between S and Ω.

The vectors e and Ω have the same direction and the first order effect of the polarization dispersion on the vector S of the sent optical signal is indicated by the equation: ∂S/∂ω=Ω\mathring{x}S, where ω is the angular frequency of the optical wave and the symbol \mathring{x} designates the vector product.

The modulus of Ω is the differential group delay of the link, i.e. the difference between the propagation times of two waves polarized with the two principal states of polarization of the link.

One principle of compensating polarization dispersion entails inserting between the link and the receiver a compensator which has a differential group delay and principle states of polarization represented by a vector Ωc such that the vector Ωt resulting from the sum Ω+Ωc is always parallel to S or zero. These two cases are shown in FIGS. 2 and 3, respectively.

One consequence of the random character of polarization dispersion is that a compensator must be adaptive and capable of creating a differential group delay (DGDc) at least equal to the maximum value of the differential group delay to be compensated.

In practice, it is also necessary to choose a measurement parameter that is convenient to obtain and that is representative of the PMDD. That parameter can be the degree of polarization of the optical signal coming from the compensator, for example, or the spectral width of the modulation of the electrical signal obtained after detection.

European patent application EP-A-853 395 filed Dec. 30, 1997 and published Jul. 15, 1998 describes a PMDD compensator.

FIG. 4 shows diagrammatically and by way of example an optical transmission system incorporating this type of compensator.

The system is a wavelength division multiplex system designed to convey a plurality of channels in the form of sent signals Seλ, Seλ′, Seλ″ carried by respective wavelengths λ, λ′, λ″. Each channel, for example the channel Seλ, comes from a sender terminal TX sending an optical signal taking the form of amplitude modulation of a polarized carrier wave. The channels are combined in a multiplexer 1 whose output is coupled to an optical transmission link LF, which is typically an optical fiber and can include optical amplifiers (not shown) at the upstream and/or downstream end of the fiber. The link can also comprise a plurality of sections of fiber with optical amplifiers between them.

The end of the link is connected to a receiver terminal RX via a demultiplexer 2 whose function is to extract the signal Sr intended for the receiver RX.

The system includes polarization dispersion compensator means CM between the demultiplexer 2 and the receiver RX which include a polarization controller PC, means DDG for generating a compensation differential group delay DGDc between two orthogonal polarization modes, and a control unit CU for the polarization controller PC.

In a first embodiment described in the aforementioned application, the means DGD generate a fixed differential group delay and consist of a polarization maintaining fiber (PMF), for example, which has the property of procuring a fixed differential delay with invariable principal states of polarization.

The polarization controller PC is controlled by the control unit CU with a view to maximizing continuously the degree of polarization of the signal coming from the differential delay generator.

The combination of the adjustable polarization controller PC and the means DDG is equivalent to an optical component that can be represented by a vector Ωc of constant modulus and whose direction varies as a function of a command sent to the polarization controller. Provided that |Ωc|>|Ω|, S and Ωt can be made colinear by sending appropriate commands to the polarization controller, which provides first order compensation. However, it has been found that some states, in particular those corresponding to situations in which S and Ω are perpendicular, reinforce higher order PMDD effects that are not negligible. These higher order effects are essentially due to the fact that the direction of Ωt is a function of ω.

This problem can be remedied by making the means DDG adjustable, as proposed in one embodiment described in the aforementioned application. In this case, the compensator is equivalent to an optical component that can be represented by a vector Ωc whose modulus and direction vary as a function of respective commands sent to the adjustable means DDG and the polarization controller. Compared to the first solution, the adjustable means DDG can in theory cancel Ωt continuously and thereby circumvent the effects of higher order PMDD.

However, for this object to be achieved, the adjustable means DDG must use a differential group delay generator adapted to the PMDD problem. In particular, its response time must be compatible with the speed of the DGD fluctuations observed in practice. Moreover, its accuracy must increase as the bit rate increases. Accordingly, the average differential group delay of an RZ binary signal after compensation must remain below one third of the bit period, which means that it is essential to be able to adjust the differential group delay of the compensator to a value close to that of the link and with an accuracy better than 33 ps if the bit rate is 10 gigabits per second or 8 ps if the bit rate is 40 gigabits per second.

One solution to the problem of providing an adjustable differential group delay generator entails using a plurality of sections of polarization maintaining fiber of different lengths and selecting that with the required DGD by means of an optical switch. However, this provides only discrete values of differential group delay and cannot achieve the required accuracy. Moreover, each time the DGD is modified, the signal is disturbed or even interrupted.

Other differential group delay generators known in the art use a polarization splitter one output of which is coupled to a plurality of selectively switched delay lines. This solution has the same drawback as previously.

The present invention seeks to alleviate the problems of the devices previously cited by proposing an adjustable differential group delay generator that is easy to use and accurate and has only a very low inertia.

### SUMMARY OF THE INVENTION

With this aim in view, the invention provides a differential group delay generator for optical signals taking the form of modulation of a carrier wave having a center wavelength, the differential group delay generator including a polarization splitter which has an input for receiving an input optical signal and is adapted to split the input signal into first and second components having orthogonal states of polarization, and an adjustable delay system for receiving the first component and including an adjustable phase modulator adapted to apply phase modulation to the carrier wave of the first component to supply an intermediate signal carried by a modified center wavelength, and a delaying dispersive component having chromatic dispersion and disposed to receive the intermediate signal and supply a delayed signal.

The device according to the invention can have either or both of the following features:

the adjustable delay system further includes a controller of the phase modulator adapted to adjust the depth of phase modulation applied to the first component as a function of a set point,

the input signal is an RZ binary signal with a particular bit period and the controller is adapted to send commands to the phase modulator periodically with a period equal to the bit period.

Thus the invention exploits the property of dispersive media, such as dispersive fibers or fibers with photo-written Bragg gratings, of imposing on an optical wave passing through them a propagation speed that is a function of the wavelength (or the optical frequency) of the wave. Using a phase modulator, it is possible to adjust a modification applied to the wavelength of the carrier wave of the pulses constituting one of the components of the input optical signal and thereby vary the propagation time of the pulses in the delaying dispersive medium.

Note that this solution is well adapted to RZ amplitude modulated optical signals because the phase modulation to be applied can be effected very simply using a clock signal at the bit frequency. For other types of modulation, such as NRZ amplitude modulation, there are additional constraints regarding the phase modulators, because the maximum variation of phase to be applied is greater.

The person skilled in the art knows that, for the conventional signals mentioned above, the effect of dispersive media is to widen the optical pulses. Also, it is necessary to take the presence of the delaying dispersive component into account if the chromatic dispersion of the delaying dispersive component must be high to provide a wide range of differential delay.

In the specific application to a polarization dispersion compensator, the pulses at the output of the delaying dispersive medium can be combined directly with the pulses of the second component extracted from the input signal. Also, compensation will be required if, because of chromatic dispersion, the pulses at the output of the delaying dispersive medium have widths that are too different from those of the second component.

The coefficient of chromatic dispersion D of a medium is related to its propagation constant β by the equation:

d²β/dω²=−(2 πc/ω²)D

in which co is the angular frequency of the optical wave and c is the speed of light in a vacuum.

As a general rule, the coefficient D can be positive, zero or negative, depending on the wavelength and the medium used. For standard fibers, for example, the chromatic dispersion is approximately +17 ps/(km.nm) for a wavelength of 1.5 μm.

A chromatic dispersion value is defined for a homogeneous or non-homogeneous dispersive component, for example a link incorporating a dispersive fiber and can be expressed mathematically by the following equation:

DL=∫D(z).dz

in which z is the abscissa of a point along the dispersive medium, D(z) is its chromatic dispersion at the abscissa z, and the integral that expresses the dispersion DL is calculated along the propagation path of waves in the dispersive medium.

Similarly, if a link comprises a plurality of dispersive components coupled in cascade, a cumulative chromatic dispersion for the link can be defined as the algebraic sign of the chromatic dispersions of the various components that form the link.

Also, to solve the problem of optical pulse widening mentioned above, the adjustable delay system can further include a second dispersive component disposed to supply to the phase modulator a precompensated component obtained from the first component of the input signal, the second dispersive component having a chromatic dispersion of the opposite sign to the chromatic dispersion of the delaying dispersive component and an absolute value not greater than that of the delaying dispersive component.

Thanks to this, the absolute values of the cumulative chromatic dispersion evaluated from the input signal and respectively as far as the input of the phase modulator and the output of delaying dispersive component are certain to remain less than the absolute value of the chromatic dispersion of the delaying dispersive component.

It is generally desirable for the pulses at the output of the delaying dispersive component not to be widened. To this end, the second dispersive component and the delaying dispersive component can have chromatic dispersions of opposite sign and substantially the same absolute value.

Of course, the foregoing implies that the input signal does not suffer any widening of its pulses due to an upstream dispersive component. If this is not the case, for example if the input signal is obtained from a signal transmitted by an optical link having a high residual chromatic dispersion, the adjustable delay system includes a second dispersive component disposed to supply to the phase modulator a compensated component obtained from the first component of the input signal, the second dispersive component having a chromatic dispersion such that the cumulative chromatic dispersion of the optical link and the second dispersive component is of opposite sign to the chromatic dispersion of the delaying dispersive component, the absolute value of the cumulative chromatic dispersion being not greater than that of the delaying dispersive component.

The presence of the second dispersive component is nevertheless indispensable only if the cumulative chromatic dispersion at the output or on the upstream side of the phase modulator, evaluated from the input signal or the sent signal, is sufficient to widen the pulses significantly. Another situation in which the second dispersive component can be dispensed with is that in which the input signal comprises a stream of soliton pulses and the chromatic dispersion of the delaying dispersive component is positive.

The invention also provides a polarization dispersion compensator for optical transmission systems including a sender terminal sending data in the form of a polarized optical signal, an optical transmission link, and a receiver terminal, the polarization dispersion compensator including a polarization controller, adjustable differential group delay generator means, the controller and the adjustable differential group delay generator means being interleaved between the transmission link and the receiver terminal in that order, and control means for controlling the polarization controller and the differential group delay generator means, which differential group delay generator means conform to the differential group delay generator as defined hereinabove.

Other advantages and features will become apparent on reading the following description, which is given by way of non-limiting example and with reference to the drawings.

### BRIEF DESCRIPTION OF THE DRAWINGS

FIG. 1 shows the Poincare space already commented on.

FIGS. 2 and 3 show two principles of polarization dispersion compensation, also already commented on.

FIG. 4 shows diagrammatically an optical transmission system including a polarization dispersion compensator, also already commented on.

FIG. 5 shows a polarization dispersion compensator according to the invention integrating a differential group delay generator according to the invention.

FIG. 6 shows a variant polarization dispersion compensator according to the invention.

FIGS. 7 and 8 are timing diagrams used to explain how the invention works.

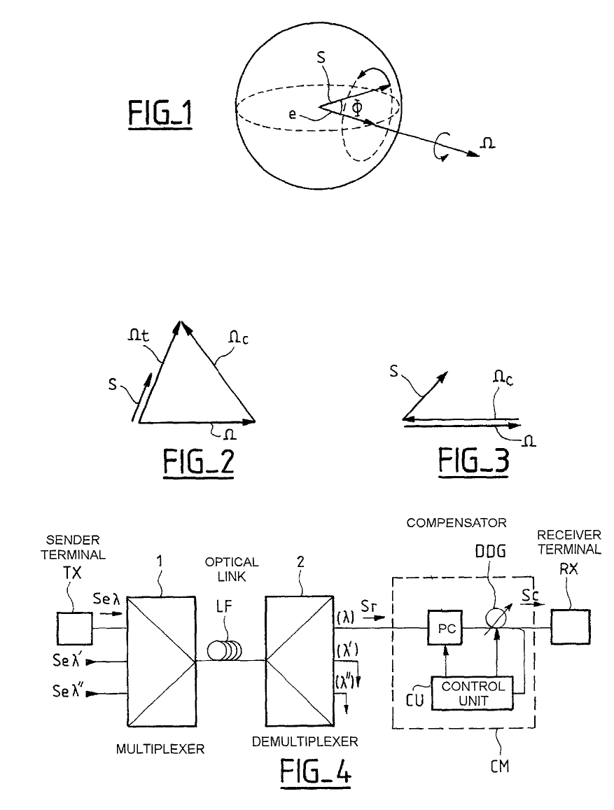

### DETAILED DESCRIPTION OF THE PREFERRED EMBODIMENTS

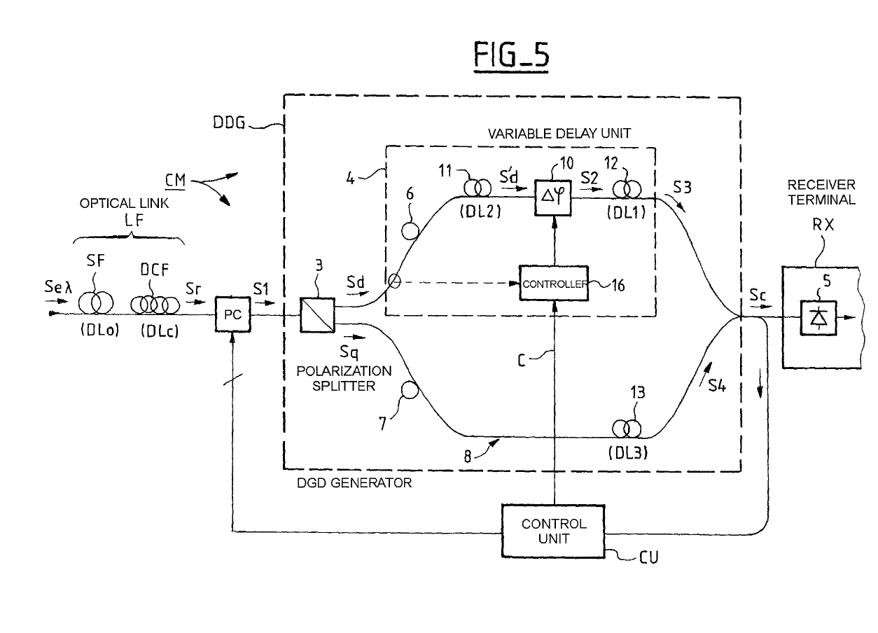

FIG. 5 shows the various components of the FIG. 4 transmission system: the link LF, the polarization dispersion compensator means CM, and the receiver terminal RX. The link LF receives at one end the sent signal Seλ and delivers the received signal Sr to the receiver. The link LF consists of an optical fiber SF, for example, with chromatic dispersion DLo, coupled to a chromatic dispersion compensating fiber DCF, with chromatic dispersion DLc.

The polarization dispersion compensator means CM include a polarization controller PC, means DDG for generating an adjustable differential group delay, and control means including a control unit CU of the polarization controller PC and the means DDG.

The signal Sr is received by the polarization controller PC which supplies the input signal S₁ to the means DDG.

The means DDG include a polarization splitter 3 which receives the input signal S₁ and extracts from it two components Sd, Sq having orthogonal states of polarization.

The component Sd is coupled to an adjustable delay system 4 including in cascade an adjustable phase modulator 10 and a delaying dispersive component 12 having a chromatic dispersion DL₁. The second component Sq is coupled to the input of a second branch 8 whose output supplies the signal S₄.

The input optical signal S₁ and its two components Sd, Sq are carried by an initial central wavelength and the modulator 10 is adapted to apply phase modulation to the carrier wave of the component Sd to supply an intermediate signal S₂ carried by a modified central wavelength.

The dispersive component 12, which is a dispersive optical fiber, for example, has the function of a delaying fiber because it has a dispersion DL₁ whose effect is that the propagation time of the signal S₂ passing through it is a function of the offset applied to the central wavelength by the phase modulator 10.

The signal coming from the fiber 12 constitutes a delayed signal S₃.

In the embodiment shown in FIG. 5, the delayed signal S₃ is coupled with the signal S₄ to form the output signal Sc, one portion of which is directed to a photodetector 5 of the receiver RX and another portion of which is directed to the control unit CU of the control means. To avoid the risk of interference between the signals S₃ and S₄, it is necessary to couple the signals by means of polarization maintaining fibers that are suitably oriented and a polarization maintaining coupler (not shown).

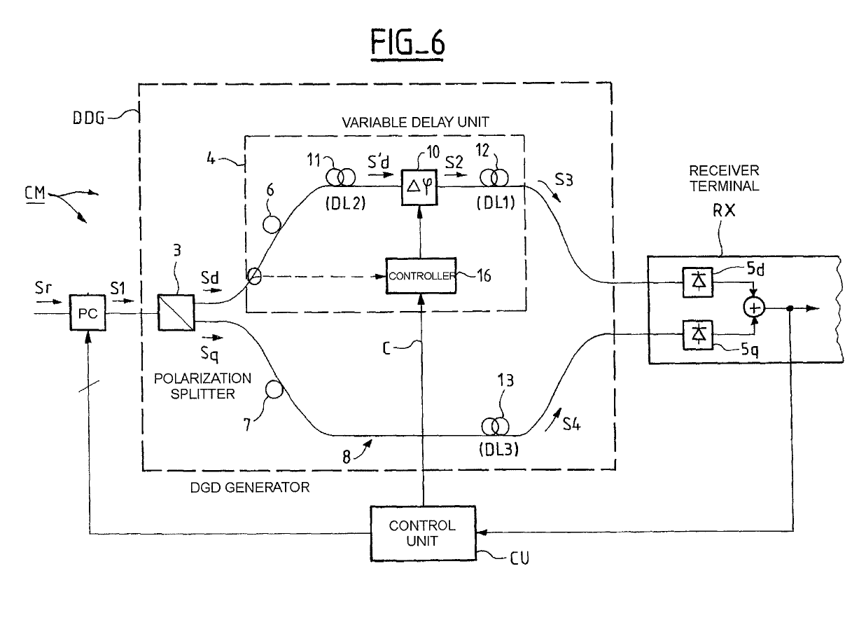

FIG. 6 shows a variant that avoids this constraint. In this variant, the signals S₃ and S₄ are not coupled optically, but are respectively directed to two photodetectors ₅d, ₅q of the receiver RX. The electrical signals produced by the photodetectors are then added to supply a received electrical signal, a portion of which is sampled to constitute a feedback signal applied to the control unit CU. In this case the control unit CU applies a control method seeking to minimize the spectral width of the modulation of the received electrical signal.

A controller 16 applies an appropriate control voltage to the phase modulator 10. Thus the controller 16 adjusts the depth of the phase modulation applied as a function of a set point C supplied by the control unit CU.

For synchronization purposes, the controller 16 receives a signal representative of the modulation of the component Sd, symbolized by the dashed line arrow. A first delays component 6 is placed at the input of the delay system 4 to enable synchronization of the controller 16 to the modulation of the signal S'd. A second delay component 7 placed in the branch 8 is also provided for static synchronization of the signals S₃ and S₄.

As previously explained, if the chromatic dispersion of the delaying fiber 12 must be taken into account to limit the widening of the pulses of the delayed signal S₃, a second precompensation dispersive component 11 is disposed between the polarization splitter 3 and the modulator 10 so that the latter receives a precompensated component S'd derived from the component Sd.

If the input signal S₁ has not suffered any widening of its pulses, for example thanks to the compensator DCF, the second dispersive component 11 then has a chromatic dispersion DL₂ of opposite sign to the chromatic dispersion DL₁ of the delaying dispersive component 12, and the absolute value of DL₂ will be not greater than that of DL₁.

It is generally desirable for the pulses at the output of the delaying dispersive component not to be widened. Thus the second dispersive component 1 has a chromatic dispersion DL₂ whose absolute value is substantially equal to that DL₁ of the delaying dispersive component 12.

However, in this situation, in which the pulses at the output of the dispersive component 12 have minimum widening due to chromatic dispersion, the pulses applied to the input of the phase modulator have maximum widening, which may be prejudicial to the operation of the modulator. This is why partial compensation could be preferable in some cases. Also, for the pulses at the output of the delaying dispersive medium to have widths analogous to those of the signal S₄derived from the second component Sq, a third compensating dispersive component 13 is advantageously disposed to receive the second component Sq and has a chromatic dispersion DL₃ substantially equal to the cumulative chromatic dispersion DL₂+DL₁ of the second dispersive component 11 and the delaying dispersive component 12.

On the other hand, the input signal S₁ may have suffered chromatic dispersion that has not been compensated. In this case, the second dispersive component 11 must take account of the cumulative chromatic dispersion of the whole of the link between the sent signal Seλ and the input signal S₁. The second dispersive component 11 then has a chromatic dispersion DL₂ such that the cumulative chromatic dispersion DLₒ+DL_{c}+DL₂ of the optical link and the second dispersive component 11 is of opposite sign to the chromatic dispersive DL₁ of the delaying dispersive component 12, the absolute value of the cumulative chromatic dispersive being not greater than that of DL₁.

As previously, minimum widening of the pulses at the output of the delaying dispersive component is obtained if the chromatic dispersive DL₂ is such that the absolute value of the cumulative chromatic dispersive DLₒ+DL_{c}+DL₂ of the optical link and the second dispersive component is substantially equal to that of DL₁.

The components of the device referred to hereinabove are well known in the optical transmission art.

Accordingly, rather than an ordinary dispersive fiber, the dispersive component 12 is preferably a component based on a fiber provided with a photo-written Bragg grating of variable period (known as a “chirped” grating). These components function by reflection and impose on the spectral components of an injected wave optical paths that are a function of their wavelength. For a given value of chromatic dispersive, these components have the advantage that the length of fiber necessary is much shorter than that of an ordinary dispersive fiber. This makes operation much more stable in the face of temperature fluctuations.

Of course, the second dispersive component is indispensable only if the chromatic dispersive of the delaying dispersive component is sufficient to widen the pulses significantly.

The problem of widening due to the delaying dispersive component can be absent or at least attenuated if the input signal consists of a stream of soliton pulses or pulses approximating solitons. Provided that a delaying dispersive component is chosen having a positive chromatic dispersive, that component compensates the widening of the pulses due to chromatic dispersive through non-linear effects (Kerr effect). It is however necessary for the amplitude of the pulses of the signal injected into the delaying dispersive component to be sufficiently high to cause the nonlinear phenomena to occur. If necessary, an optical amplifier can be provided on the upstream side of the delaying dispersive component.

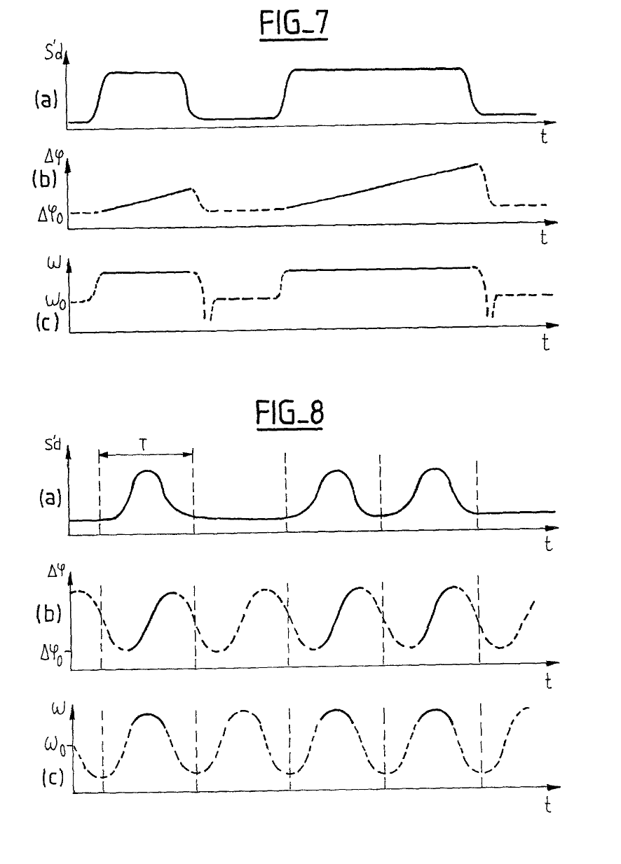

The timing diagrams shown in FIGS. 7 and 8 are used to explain the operating principle of the invention.

In FIG. 7 the input signal S₁, and thus its component Sd or S'd, takes the form of amplitude modulation of a carrier wave whose wavelength corresponds to an angular frequency co. Timing diagram (a) shows an example of variations of the amplitude of the signal S'd as a function of time t.

At the output of the modulator 10, the signal S₂ has an analogous amplitude modulation and can be expressed as a function of time t by the following equation:

S₂=A(t)cos(ωo.t+Δφ)

in which A(t) is the modulated amplitude, ω0 the angular frequency of the signal S'd and Δφ the phase shift between the signals S₂ and S'd created by the modulator.

If the command sent to the modulator 10 is not modulated, S₂ retains the angular frequency ω0 of the signal S'd.

On the other hand, if the command is modulated, Δφ varies as a function of time and the angular frequency of S₂ becomes:

ω=ω0+d(Δφ)/dt

Accordingly, by sending to the modulator 10 a command such that the variations of the phase shift Δφ as a function of time t have a non-zero slope d(Δφ/dt, the angular frequency ω of the carrier wave of S₂ is shifted relative to ω0 by an amount proportional to that slope. In particular, if the slope is constant, the shift between ω and ω is constant.

In practice, as the phase cannot be increased or decreased indefinitely, the phase shift Δφ is modulated so that the shift has the required slope during each pulse of the signal S'd, an opposite shift being produced during the low levels of optical power of the signal. The timing diagram (b) shows this phase modulation at substantially constant slope during the pulses. The result is the variation of the angular frequency ω as a function of time t shown by the timing diagram (c).

To adjust the delay as a function of the set point C, the controller 16 sends to the phase modulator 10 a command to create phase modulation whose modulation depth is a function of the set point. Also, the command is synchronized with amplitude modulation of the signal S'd, as symbolized by the dashed line arrow in FIG. 1. If necessary, the signal S'd can be delayed by an appropriated fixed time-delay 6 before injecting it into the modulator 10, to take account of the time of electronic processing by the controller 16.

Compared to a signal that has not been subjected to phase modulation, the pulses of the signal S₃ coming from the delaying fiber 12 have a delay or an advance proportional to the absolute values of the chromatic dispersive DL₁ of the delaying fiber and the shift between the angular frequencies ω and ω0 . Also, a delay or an advance is obtained according to the sign of the chromatic dispersive DL₁ and the sign of the shift between the angular frequencies.

Thus the relative delay applied to the signal S'd is a function of the following three parameters:

the chromatic dispersive coefficient D of the delaying fiber,

its length, and

the slope d(Δφ)/dt of the phase shift Δφ as a function of time t.

It is therefore possible to determine the range of variation of the delay by the choice of the type of dispersive fiber and its length, and by the slope as a function of time in accordance with which the modulator 10 is controlled.

In FIG. 8 the RZ signal S'd (timing diagram (a)) is clocked by a clock of period T defining the bit period.

In practice, and especially at high bit rates, it is easier to obtain electrical control voltages that are modulated substantially sinusoidally, derived from a clock signal having the bit frequency, as shown in timing diagram (b). If this clock signal is not otherwise available, it can be created from the signal Sd using a clock recovery device provided in the controller 16, as symbolized by the dashed line arrow in FIG. 5.

Accordingly, the controller 16 sends commands to the phase modulator 10 periodically with a period equal to the bit period T to create phase modulation whose modulation depth is adjusted as a function of the set point C.

As shown diagrammatically by the timing diagram (c), the angular frequency shift is not constant, but its fluctuations become less critical as the width of the pulses of the signal is decreased.

Finally, if the differential group delay generator is used in the polarization dispersive compensator previously described, the maximum phase modulation depth that can be applied to the component Sd and/or the chromatic dispersive DL₁of the delaying dispersive component 12 are chosen to obtain a delay range that is at least equal to twice the bit period of the input signal.

There is claimed:

1. A differential group delay generator for optical signals taking the form of modulation of a carrier wave having a center wavelength, said differential group delay generator including a polarization splitter which has an input for receiving an input optical signal and is adapted to split said input signal into first and second components having orthogonal states of polarization, and an adjustable delay system for receiving said first component and including an adjustable phase modulator adapted to apply phase modulation to the carrier wave of said first component to supply an intermediate signal carried by a modified center wavelength, and a delaying dispersive component having chromatic dispersive and disposed to receive said intermediate signal and supply a delayed signal.

2. The differential group delay generator claimed in claim 1 wherein said adjustable delay system further includes a controller of said phase modulator adapted to adjust the depth of phase modulation applied to said first component as a function of a set point.

3. The differential group delay generator claimed in claim 2 wherein said input signal is an RZ binary signal with a particular bit period and said controller is adapted to send commands said phase modulator periodically with a period equal to said bit period.

4. The differential group delay generator claimed in claim 1 wherein said adjustable delay system includes a second dispersive component adapted to supply to said phase modulator a precompensated component derived from said first component, said second dispersive component having a chromatic dispersive of opposite sign to the chromatic dispersive of said delaying dispersive component and whose absolute value is not greater than that of said delaying dispersive component.

5. The differential group delay generator claimed in claim 4 wherein said second dispersive component has a chromatic dispersive whose absolute value is substantially equal to that of said delaying dispersive component.

6. The differential group delay generator claimed in claim 1 wherein said input signal is derived from a signal transmitted by an optical link, said adjustable delay system includes a second dispersive component adapted to supply to said phase modulator a compensator component derived from said first component, said second dispersive component having a chromatic dispersive such that the cumulative chromatic dispersive of said optical link and said second dispersive component is of opposite sign to the chromatic dispersive of said delaying dispersive component, and the absolute value of said cumulative chromatic dispersive being not less than that of said delaying dispersive component.

7. The differential group delay generator claimed in claim 4 or claim 6, including a third compensating dispersive component adapted to receive said second component and having a chromatic dispersive substantially equal to the cumulative chromatic dispersive of said second dispersive component and said delaying dispersive component.

8. The differential group delay generator claimed in claim 7 wherein said second dispersive component has a chromatic dispersive such that the absolute value of said cumulative chromatic dispersive of said optical link and said second dispersive component is substantially equal to that of said delaying dispersive component.

9. A polarization dispersive compensator for optical transmission systems including a sender terminal sending data in the form of a polarized optical signal, an optical transmission link, and a receiver terminal, said polarization dispersive compensator including a polarization controller, adjustable differential group delay generator means, said controller and said adjustable differential group delay generator means being interleaved between said transmission link and said receiver terminal in that order, and control means for controlling said polarization controller and said differential group delay generator means, which differential group delay generator means conform to the differential group delay generator claimed in any of claims 1 to 6.
